(19) United States
(12) Patent Application Publication
(10) Pub. No.: US 2009/0205947 A1
(43) Pub. Date: Aug. 20, 2009

(54) METHOD FOR THE REDUCTION OF MALODOROUS COMPOUNDS

(76) Inventors: John Barkanic, Schnecksville, PA (US); Joseph William Cresko, Bethlehem, PA (US)

Correspondence Address: RATNERPRESTIA, P.O. BOX 980, VALLEY FORGE, PA, 19482, US

(21) Appl. No.: 11/815,796

(22) PCT Filed: Feb. 10, 2006
(86) PCT No.: PCT/US2006/004755

§ 371 Date: Oct. 29, 2008

Related U.S. Application Data
(60) Provisional application No. 60/651,811, filed on Feb. 10, 2005.

(51) Int. Cl. B01D 53/54; B01J 19/08

(52) U.S. Cl. 204/157.3; 204/157.44

(57) ABSTRACT

A method is provided for removing malodorous compounds, such as trimethylamine (TMA), present in an exhaust gas. At least one low-voltage electron beam energy source is used to remove small quantities of malodorous compounds in air. The electron beam energy source can also be used to beneficially form ozone to enhance the EB reduction of small quantities of compounds such as TMA in air.

### FIELD OF THE INVENTION

The present invention is directed to a method for removal of malodorous compounds from a gaseous stream, and more particularly, for removing trimethylamine in exhaust gases.

### BACKGROUND OF THE INVENTION

Environmental odor pollution problems (malodors) generate a significant fraction of publicly initiated complaints received by air pollution control districts (“Critical Review: The Health Significance of Environmental Odor Pollution,” Archives of Environmental Health, January-February 1992 v47 n1 p76(12)). As noted by Dennis Shusterman in that review, “Noxious environmental odors may trigger symptoms by a variety of physiologic mechanisms, including exacerbation of underlying medical conditions, innate odor aversions, aversive conditioning phenomena, stress induced illness, and possible pheromanal reactions.” The sources of such odors can be municipal, agricultural or industrial and are typically well-known within a community, but due to the transient nature of exposures, abatement and enforcement has often been difficult. Air pollution standards are typically applied to either emissions or ambient air quality as a means to regulate malodors. Emission standards have been used by the EPA to regulate specific industries, and local jurisdictions have begun to impose emissions standards (for example the San Francisco Bay Area Air Quality Management District has established emission standards for 5 types of compounds: dimethylsulfide, ammonia, mercaptans, phenolic compounds and trimethylamine).

Trimethylamine (TMA) is one example of a malodorous gas. Specifically, TMA is a gas produced by the decomposition of fish; it is a breakdown product of ATP-related compounds in the fish's muscle tissue (Science News, Oct. 29, 1988 v134 n18 p287(1)). Fish food manufacturers are particularly prone to emit malodorous TMA because fish food comes from processed fish. During the processing of fish food, a small amount of trimethylamine (TMA) is released and results in fugitive and point source emissions from the plant. Although the concentration released is very low (on the order of a few parts per million (ppm)) and poses no health risk, TMA is a very offensive odor and can be classified as a malodor. The TMA malodor produced at fish food manufacturers has resulted in a long-standing problem between the company and local residents, and the residents have lodged many complaints over the years. Certain companies have taken a number of positive steps toward resolving a malodor problem associated with TMA emissions.

Nevertheless, there remains a need for an improved method for the reduction of malodorous compounds such as TMA.

### SUMMARY OF THE INVENTION

The present invention relates to a method of remedying malodorous compounds present in an air stream as an unwanted by-product from a process. More specifically, the invention relates to a method of removing malodorous compounds, such as trimethylamine (TMA), present in an air stream. In another aspect, the invention relates to a method of using at least one low-voltage electron beam energy source to remove small quantities of malodorous compounds in air. In yet another aspect, the invention relates to the use of the electron beam energy source to beneficially form ozone to enhance the reduction of small quantities of compounds such as TMA in air.

According to one exemplary embodiment, the present invention provides a method for removing compounds from a gaseous exhaust stream by contacting the exhaust stream with a low energy electron beam (EB) energy source. According to another exemplary embodiment, the present invention provides a method for removing trimethylamine (TMA) from a gaseous exhaust stream by contacting the exhaust stream containing TMA with a low-voltage electron beam energy source and forming ozone.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates a malodorous compound abatement system that can be used to perform malodorous compound abatement according to an exemplary embodiment of the present invention;

FIG. 2 illustrates an exemplary electron beam emitter arrangement that can be used as a component of the malodorous compound abatement system of FIG. 1;

FIG. 3 is a flow chart of a process for abating malodorous compounds according to an exemplary embodiment of the present invention;

FIG. 4 is a plot showing the correlation between applied EB power and the reduction of TMA concentration in an air stream at 53 cfm; and

FIG. 5 is a plot showing the correlation between applied EB power and the reduction of TMA concentration in an air stream at 23 cfm.

### DETAILED DESCRIPTION OF THE INVENTION

According to one exemplary embodiment, this invention provides a method for the remediation of malodorous compounds in an air stream, such as from an exhaust stream from a manufacturing process, through the use of relatively low energy electron beams. The method of the invention can be used to suppress a wide range of malodorous compounds without the generation of unwanted breakdown components. For example, according to an exemplary embodiment of the present invention, the amine containing compound, trimethylamine (TMA), contained in an air stream in concentrations less than 0.05% on a volume basis, is removed from a gaseous stream without the significant generation of unwanted nitrogen oxides (NOx). According to another exemplary embodiment of the present invention, the concomitant in-situ production of ozone generated by the electrons interacting with atmospheric oxygen improves the abatement efficiency process. Abatement efficiencies are effected by operating in a specific parameter space (including concentration, residence time, applied energy, electron flux density, relative humidity).

According to an exemplary embodiment of the present invention, a dual electron beam emitter device is optionally used as a source of electron beams to abate low concentrations of gaseous compounds. A dual beam electron emitter produces electrons by passing an electric current (beam current) through a tungsten filament in a vacuum, and those electrons are accelerated by an electric field potential (voltage) through a titanium window (the titanium window necessary to maintain vacuum at the filament). The number of electrons emitted per unit time is proportional to the beam current, and the speed at which they accelerate is proportional to the accelerating voltage; the beam current and accelerating voltage define the beam power.

To the extent to which malodorous compounds are reduced, and which ozone (from atmospheric oxygen) is produced by the abatement system, is principally a function of the dose of electron beam (EB). EB dose is a function of EB power and exposure (minus the losses that occur at the titanium window). EB power can be controlled by varying the beam current and/or voltage. Exposure is a function of volumetric flow rate of the effluent stream and the geometry of the chamber wherein the effluent is exposed to the EB.

Although not intending to be bound to a particular theory, it is believed that energy in the applied EB dose disrupts the chemical bonds of the malodorous compound. An exemplary malodorous compound is the tertiary amine TMA, having a chemical formula of (CH₃)₃N. The extent to which TMA is reduced depends on the energy applied by the EB dose to likely disrupt the C—H bonds and/or the C—N bonds. This bond energy, also called dissociation energy, is defined as the amount of energy needed to rupture all of a particular type of chemical bond in one mole of gaseous molecules to give gaseous atoms as products. Bond energies are nearly the same in many different compounds. For example, average bond energies in polyatomic molecules can be found in Table 1.

TABLE 1
Average Bond Energies

| Bond | Bond Energy (kJ/mol) |
|---|---|
| C—H | 413 |
| C—O | 351 |
| C=0 | 715 |
| C—C | 348 |
| C═C | 615 |
| C≡C | 812 |
| C—N | 292 |
| C═N | 615 |
| C≡N | 891 |
| N≡N | 945 |
| C—F | 439 |
| C—Cl | 328 |
| H-0 | 464 |
| H—N | 391 |
| O═O | 498 |

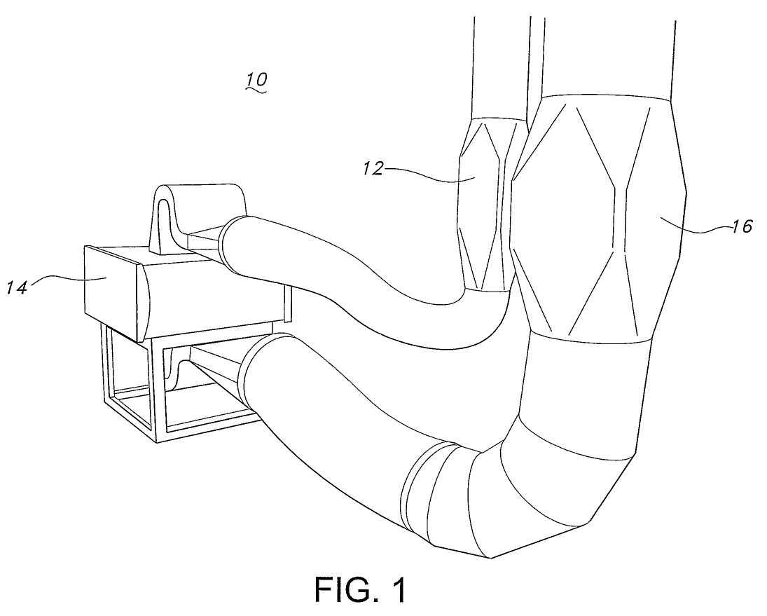

FIG. 1 illustrates an exemplary system for reduction of malodorous compounds that can be used to perform a method according to an embodiment of the present invention. System 10 includes a gas input 12 for a feed gas, a electron beam emitter 14, and an exhaust gas output 16.

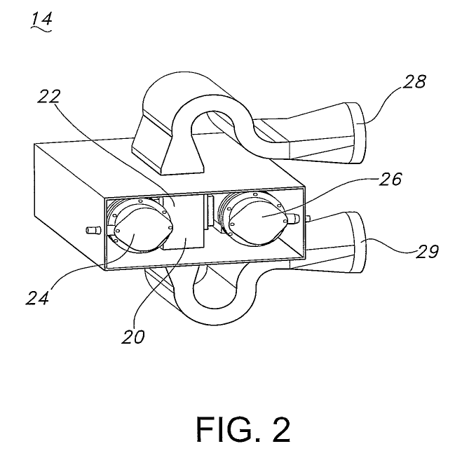

Electron beam (EB) system 14 is illustrated in more detail in FIG. 2. EB system 14 has a reaction zone 20 having a rectangular shaped duct 22 with opposing EB emitters 24 and 26 on opposing sides of duct 22. This configuration of emitters provides a substantially uniform dose of energy across reaction zone 20. Gas will flow in reaction zone 20 in a perpendicular pattern between EB emitters 24 and 26. EB system 14 has an inlet port 28 and outlet port 29, which according to one exemplary embodiment, is a 10-inch diameter duct for the introduction of a malodorous gas to be treated, and additionally fitted with ¼ inch swage-lock fittings to accommodate the introduction of known malodorous compounds for testing in a laboratory situation.

An example of a dual beam electron emitter is available from Advanced Electron Beams, Inc., 10 Upton Drive, Wilmington, Mass. 01887, such as the eTronBeam-100. Also, examples of electron beam emitters are disclosed in U.S. Pat. No. 6,702,984 entitled “Decontamination Apparatus,” U.S. Pat. No. 6,674,229 entitled “Electron Beam Emitter,” U.S. Pat. No. 6,630,774 entitled “Electron Beam Emitter,” and U.S. Pat. No. 6,407,492 entitled “Electron Beam Accelerator”, the contents of which are incorporated herein by reference in their entirety. In order to accommodate increased volumetric flow rates of malodorous gas to be treated, multiple EB systems can be arranged in parallel and/or in series and/or EB systems can be expanded to contain a greater number of EB emitters. According to an alternative embodiment, a fractional portion of the exhaust gas may be recirculated. With this arrangement, it may be possible to improve the destruction efficiency of certain compounds and/or increase the capacity of exhaust gas that can be treated by a fixed number of EB emitters.

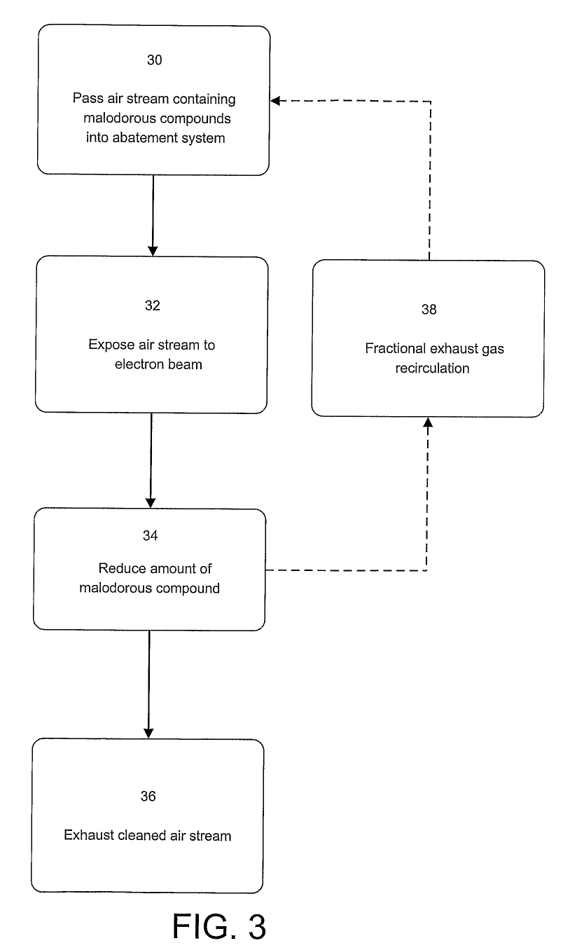

FIG. 3 is a flow chart describing an exemplary process for abating malodorous compounds according to an exemplary embodiment of the present invention. As shown in block 30, an air stream containing a malodorous compound is fed into the abatement system. The air stream is then exposed to low energy electron beams as shown in block 32. Block 34 shows the malodorous compounds are substantially removed from the air stream. Block 36 shows the substantially cleaned air stream is exhausted to the atmosphere. As shown by the dashed line and arrows, a fractional portion of the air stream, shown by block 38, is optionally recycled and returned to the abatement system.

Analytical tests were performed to establish the concentrations of TMA, ozone, nitric oxide, and nitrogen dioxide in the output gas feed of an EB malodorous abatement system. Testing was completed using detection tubes (available from Gastek Corporation, Kanagawa, Japan) by sampling air suspected of containing a gaseous compound of interest, TMA, drawn into the test tube. The test tube was packed with a media material that reacts with TMA. Reaction of the media material in the test tube generates a color change, which indicates the concentration at the sample location in parts per million (ppm). Table 2 specifies the tube used for analyzing individual compounds in the inlet and exit streams.

TABLE 2
Gastek Tubes used for Exhaust Stream Analysis.

| Compound | Gastek Tube Number |
|---|---|
| NOₓ | 11L |
| Ozone | 18M |
| TMA | 180, 180L |

A lecture bottle of TMA was used as the control in the input gas of the system. The gas flow rate was regulated by fitting a pressure gauge, rotometer, and metering valve to the lecture bottle. Flow rates of the gas typically varied between 4 to 50 standard cubic centimeters per minute (sccm).

EB Interaction with Air

Tests were performed with the EB abatement system to establish the effects of the EB interaction with ambient air. The main concern was the extent to which electrons interact with nitrogen or oxygen molecules in the chamber. Since air consists of 79% nitrogen and 21% oxygen, the major concern was the formation of NOx and ozone resulting from the interactions with electrons. Tests were performed to determine if these compounds were formed, the effect of various concentrations of TMA, and the effect of NOx and ozone on the destruction of TMA.

Tests were also conducted using a volumetric flow rate of air of approximately 20 standard cubic feet per minute (scfm). Gas testing was done using the Gastek Tube No. 11L for NOₓ. This detection tube analyzes for nitric oxide, NO, as well as nitrogen dioxide, NO₂. The exiting air stream was tested for NOₓ compounds with the EB system off. No NOₓ compounds were found. When the EB system was turned on at the highest voltage and current possible (100 kV, 10 milliamp), the quantity of NOₓ in the exit stream was still not detectable. In other words, under these operating conditions at ambient temperature, electrons interacting with diatomic molecular nitrogen are not energetic enough to form NOₓ compounds.

EB Generation of Ozone

Tests were run to establish the concentrations of ozone present in the abatement system. The Gastek Tube No. 18M was used to determine ozone concentrations. These tests were done with an airflow rate of approximately 20 scfm and no TMA present. At the exit of the EB system, concentrations of ozone typically varied between 100 and 160 parts per million (ppm). The concentration of ozone varied little as the voltage and current were changed. The presence of small quantities of ozone in the EB system is expected to enhance the overall efficiency of destruction.

Preliminary EB Tests with TMA

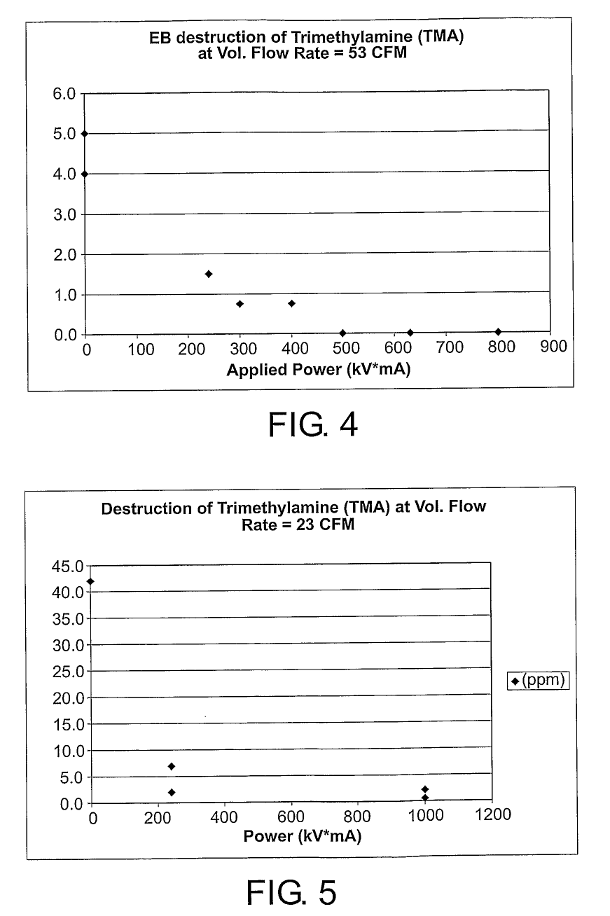

Tests were performed to ascertain whether the EB energy would reduce the TMA present in an airstream. TMA was introduced into the EB system under varying conditions of TMA concentration, volumetric flowrates of air, and applied power output of the EB power supply. In FIG. 4, the volumetric flowrate through an exemplary abatement system was set at 53 scfm and TMA was fed to the airstream at the inlet. Measurements of the TMA at the outlet with the EB system turned off (applied power=zero) were measured at between 4 and 5 ppm TMA. With the EB power turned on and at different power level settings, the TMA is reduced. With higher EB power levels, it was observed that a greater reduction of TMA occurred. FIG. 5 shows similar data, but with lower volumetric flowrate of the air stream (23 scfm) and a higher initial concentration of TMA in the air stream (approximately 42 ppm TMA).

TMA Tests at Low Flow Rates

In these experiments, the total flow was maintained constant at approximately 4 scfm. The TMA was introduced at a flow rate of 6 scfm. At these flow rates, the concentration of TMA at the inlet to the EB abatement system was approximately 30 ppm. Three sets of experimental conditions were tested as described below:

1. TMA in dry air (˜0% RH)

2. TMA in dry nitrogen+ambient air

3. TMA in ambient air with moisture added (>99% RH)

For each of these three conditions, a text matrix was run that varied the input voltage and emitter current. Typical input voltage varied between 80 and 100 kilovolts and a typical emitter current ranged from 3 to 10 milliamps.

Table 3 represents the results from the testing performed at a flow rate of 4 scfm and an input concentration of 30 ppm. The table shows the input voltage in kilovolt and current in milliamp used for each experimental condition, and the exit concentration for TMA in parts per million under those operating conditions. The three columns representing Tests 1, 2, and 3 represent the three different feed gas compositions going into the EB system.

TABLE 3
TMA Reduction at Low Flow Rates -
ppm of TMA (from 30 ppm)

| | | | | Test 3: |
|---|---|---|---|---|
| Kilo- | Milli- | Test 1: | Test 2: | TMA in High RH |
| volt | amp | TMA in Dry Air | TMA in Dry N₂ | Air (>99% RH) |
| 100 | 10 | 1 | 3 | 1 |
| 100 | 6 | 1.5 | 1 | 1.5 |
| 100 | 3 | 1.5 | 3 | 0.8 |
| 90 | 10 | 1.5 | 1 | 1.5 |
| 90 | 6 | 1 | 3 | 1.5 |
| 90 | 3 | 0.9 | 3 | 0.9 |
| 80 | 10 | 2 | — | 1.5 |
| 80 | 6 | 1.5 | — | 1.8 |
| 80 | 3 | 2 | 6 | 1.8 |

To impart moisture into the gas feed, the input (shown by input 12 in FIG. 1) was fitted a refrigerated/heated bath from Thermo Neslab (Model RTE 740). The bath provided a continuous source of water vapor to be carried into the input gas stream. Airflow rates and humidity were monitored at the inlet to the EB system (shown in as inlet 28 in FIG. 2) using a hand-held flow velocity-humidity gauge manufactured by TIF, Model No. VA500A. In addition, the output gas feed from the EB system (shown as gas output 16 in FIG. 1) was fitted with a variable speed exhaust fan. The exhaust-side blower and damper system can move from 5 to 1,000 cubic feet per minute of effluent. Volumetric flow rates in output gas feed could also be measured using a probe manufactured by Omega Instruments.

An analysis of the data in Table 3 indicates that the amount of TMA in air passing through the EB abatement system is reduced. Test 1 for TMA in dry air, indicates exit concentrations of TMA between 1 and 2 ppm. These results seem to span the entire operating range of voltage and current in the emitter. In general, there appears to be a minor difference in the exit gas concentration of TMA as a function of input voltage or emitter current. For Test 2, using pure dry nitrogen to dilute the TMA, the same set of conditions was tested. Across the range of each parameter tested, a slightly higher TMA concentration was observed in the exit stream. Test 3 used an ambient air stream laden with moisture to dilute the TMA. As the results indicate, TMA is successfully destroyed under conditions where moisture is present in the air stream entering the EB abatement system. The concentration of TMA in the exit gas stream once again varied between 1 and 2 ppm consistent with data observed for Test 1. The results indicate that the presence of moisture is not deleterious to the overall mechanism of reduction of malodorous compounds. Although not intending to be bound to a particular theory, the test results also indicate that oxygen present in the effluent stream may be beneficial in the destruction of TMA through the formation of ozone.

TMA Tests at High Flow Rates

Additional experimentation was conducted at a higher volumetric flow rate of air through the EB abatement system. In these experiments, a total volumetric flow rate of 200 scfm was used. TMA was metered into the gaseous air stream to a concentration of approximately 5 ppm. Testing was done under conditions with and without moisture present in the air stream. Experimental operating conditions of the EB system were varied and the exit concentration of TMA was tested. Input voltage was varied between 80 and 100 kV and the emitter current was varied between 3 and 10 milliamp. Table 4 summarizes the results for higher volumetric flow rate experimentation.

TABLE 4
TMA Reduction at High Flow Rates - ppm of TMA (from 5 ppm)

| kV | Milliamp | Air | Air + Moisture |
|---|---|---|---|
| 100 | 10 | 0.5 | 0.5 |
| 100 | 6 | 0.5 | 0.5 |
| 100 | 3 | 0.8 | 0.8 |
| 80 | 10 | 0.5 | 0.8 |
| 80 | 6 | 1 | 1 |
| 80 | 3 | 1.8 | 2 |

Under conditions of 200 cubic feet per minute of relatively dry air and 5 ppm of TMA in the inlet stream, the EB system removed the TMA to levels of approximately 0.5 ppm. At these flow rates and TMA concentrations, there was a slight difference in the exiting gas concentration of TMA based on kilovolts input to the emitter. Both 100 kV and 80 kV removed TMA to a concentration of 0.5 ppm in the exhaust when operating at 10 milliamp. Otherwise, a decrease in input voltage resulted in a reduction of the decrease in TMA concentration in the exit stream. There was an observed correlation with the emitter current at a voltage of 80 kV. There was also an observed decrease in the TMA concentration when the emitter current was increased. For example, when the emitter current increased from 3 to 10 milliamp, the exit gas concentration of TMA was decreased from 1.8 ppm to 0.5 ppm, indicating dose dependence.

The same experimental matrix was repeated using 200 cubic feet per minute and approximately 5 ppm of TMA. In this set of experiments the air was laden with moisture. Under these conditions operating at 100 kV and 10 milliamp, only 0.5 ppm TMA remained in the exhaust. At 100 kV and 3 milliamp, TMA concentration increased to 0.8 ppm. While operating at 80 kV and 10 milliamp, the exit gas concentration of TMA was 0.8 ppm. The TMA concentration was observed to increase as the current from the emitter was decreased. A decrease in emitter current to 3 milliamp resulted in a concentration of 2 ppm of TMA in the exhaust.

What is claimed:

1. A method for removing a malodorous compound from a gaseous exhaust stream, the method comprising the step of:
contacting said exhaust stream with a low energy electron beam (EB) energy source.

2. The method of claim 1 wherein the malodorous compound comprises trimethylamine (TMA).

3. The method of claim 2 wherein the gaseous exhaust stream has a concentration of TMA that is less than about 1% on a volume basis.

4. The method of claim 2 wherein the gaseous exhaust stream has a concentration of TMA that is less than about 500 parts per million on a volume basis.

5. The method of claim 1 wherein the EB energy source operates at a voltage of less than about 5,000 kilovolts.

6. The method in claim 1 wherein the energy source operates at a voltage of less than about 500 kilovolts.

7. The method of claim 1 wherein the energy source operates at a voltage of less than about 200 kilovolts.

8. The method of claim 1 wherein the energy source emits an electron impact energy that is less than the bond energy for diatomic nitrogen, thereby minimizing the formation of nitrogen-oxygen (NOx).

9. The method of claim 8 wherein the electron impact energy is less than about 945 kilojoule per mol.

10. The method of claim 1 further comprising forming an oxygen radical when the energy source emits an electron impact energy that is greater than the bond energy for diatomic oxygen.

11. The method of claim 10 wherein the electron impact energy is greater than about 498 kilojoule per mol.

12. The method of claim 10 further comprising forming ozone by contacting the oxygen radical with diatomic oxygen.

13. The method of claim 1 wherein the energy source emits an electron impact energy that is greater than an average carbon-hydrogen or carbon-nitrogen bond energy in a trimethylamine (TMA) molecule.

14. The method of claim 13 wherein the average carbon-hydrogen bond energy is about 413 kilojoule per mol and the average carbon-nitrogen bond energy is about 292 kilojoule per mol for a TMA molecule.

15. A method for removing trimethylamine (TMA) from a gaseous exhaust stream, the method comprising the steps of:
contacting the exhaust stream containing TMA with a low-voltage electron beam energy source; and
forming ozone.

16. The method of claim 15 wherein the gaseous exhaust stream is a mixture of TMA in air.

17. The method of claim 15 wherein the gaseous exhaust stream has a concentration of TMA that is less than about 1% on a volume basis.

18. The method of claim 15 wherein the gaseous exhaust stream has a concentration of TMA that is less than about 500 parts per million on a volume basis.

19. The method of claim 15 wherein the low-voltage electron beam energy source operates at a voltage less than about 5,000 kilovolts.

20. The method in claim 15 wherein the low-voltage electron beam energy source operates at a voltage less than about 500 kilovolts.

21. The method of claim 15 wherein the low-voltage electron beam energy source operates at a voltage of less than about 200 kilovolts.

22. The method of claim 15 wherein the low-voltage electron beam energy source emits an electron impact energy that is less than the bond energy for diatomic nitrogen, thereby minimizing the formation of nitrogen-oxygen pollutants.

23. The method of claim 22 wherein the electron impact energy is less than about 945 kilojoule per mol.

24. The method of claim 15 further comprising forming an oxygen radical when the low-voltage electron beam energy source emits an electron impact energy that is greater than the bond energy for diatomic oxygen.

25. The method of claim 24 wherein the electron impact energy is greater than about 498 kilojoule per mol.

26. The method of claim 24 further comprising forming ozone by contacting the oxygen radical with diatomic oxygen.

27. The method of claim 15 wherein the low-voltage electron beam energy source emits an electron impact energy that is greater than an average carbon-hydrogen or carbon-nitrogen bond energy in the TMA.

28. The method of claim 27 wherein the average carbon-hydrogen bond energy is about 413 kilojoule per mol and the average carbon-nitrogen bond energy is about 292 kilojoule per mol for a TMA molecule.

29. The method of claim 3 further comprising reducing the concentration of TMA by 90%.

30. The method of claim 3 further comprising reducing the concentration of TMA by 99%.

31. The method of claim 15 further comprising reducing the concentration of TMA by 90%.

32. The method of claim 15 further comprising reducing the concentration of TMA by 99%.
